(19) United States
(12) Patent Application Publication
(10) Pub. No.: US 2026/0366969 A1
(43) Pub. Date: Nov. 19, 2026

(54) AUTOMATED DILUTION SYSTEM WITH DEGASSING OF SYRINGE-DRIVEN FLUIDS

(71) Applicant: Elemental Scientific, Inc., Omaha, NE (US)

(72) Inventors: Stasia Vannoni, Omaha, NE (US); Daniel R Wiederin, Omaha, NE (US)

(21) Appl. No.: 19/676,101

(22) Filed: May 13, 2026

Related U.S. Application Data
(60) Provisional application No. 63/805,532, filed on May 14, 2025.

(51) Int. Cl. G01N 1/38; G01N 1/14

(52) U.S. Cl. CPC G01N 1/38; G01N 1/14; G01N 2001/1427; G01N 2001/381

(57) ABSTRACT

Automated systems and methods for degassing fluids used in syringe-driven dilution of samples for analysis are described. A system embodiment includes, but is not limited to, a valve; a syringe pump fluidically coupled with the valve; a degasser fluidically coupled with the valve; and a system controller communicatively coupled with the valve and the syringe pump, the system controller configured to instruct the valve to transition between a load configuration and a dispense configuration and to coordinate operation of the syringe pump, wherein in the load configuration, the valve fluidically couples the syringe pump with the degasser and the syringe pump draws fluid through the degasser to remove dissolved gases to provide a degassed fluid, and wherein in the dispense configuration, the syringe pump pushes the degassed fluid through the valve at a flow rate commensurate with a predetermined dilution factor to dilute a sample according to the dilution factor.

### CROSS-REFERENCE TO RELATED APPLICATIONS

The present application claims the benefit of 35 U.S.C. § 119(e) of U.S. Provisional Application Ser. No. 63/805,532, filed May 14, 2025, and titled “AUTOMATED DILUTION SYSTEM WITH DEGASSING OF SYRINGE-DRIVEN FLUIDS.” U.S. Provisional Application Ser. No. 63/805,532 is herein incorporated by reference in its entirety.

### BACKGROUND

Inductively Coupled Plasma (ICP) spectrometry is an analysis technique commonly used for the determination of trace element concentrations and isotope ratios in liquid samples. ICP spectrometry employs electromagnetically generated partially ionized argon plasma which reaches a temperature of approximately 7,000K. When a sample is introduced to the plasma, the high temperature causes sample atoms to become ionized or emit light. Since each chemical element produces a characteristic mass or emission spectrum, measuring the spectra of the emitted mass or light allows the determination of the elemental composition of the original sample.

Sample introduction systems may be employed to introduce the liquid samples into the ICP spectrometry instrumentation (e.g., an Inductively Coupled Plasma Mass Spectrometer (ICP/ICP-MS), an Inductively Coupled Plasma Atomic Emission Spectrometer (ICP-AES), or the like) for analysis. For example, a sample introduction system may withdraw an aliquot of a liquid sample from a container and thereafter transport the aliquot to a nebulizer that converts the aliquot into a polydisperse aerosol suitable for ionization in plasma by the ICP spectrometry instrumentation. The aerosol generated by the nebulizer is then sorted in a spray chamber to remove the larger aerosol particles. Upon leaving the spray chamber, the aerosol is introduced into the plasma by a plasma torch assembly of the ICP-MS or ICP-AES instruments for analysis.

### SUMMARY

Automated systems and methods for degassing fluids used in syringe-driven dilution of samples for analysis are described. A system embodiment includes, but is not limited to, a valve system including at least one valve configured to transition between a load configuration and a dispense configuration; a pump system including at least one syringe pump fluidically coupled with the at least one valve; a degasser fluidically coupled with the at least one valve and configured to fluidically couple with a fluid source; and a system controller communicatively coupled with each of the valve system and the pump system, the system controller configured to instruct the at least one valve to transition between the load configuration and the dispense configuration and to coordinate operation of the at least one syringe pump, wherein in the load configuration, the at least one valve fluidically couples the at least one syringe pump with the degasser and the system controller instructs the at least one syringe pump to draw fluid from the fluid source through the degasser to remove dissolved gases within the fluid to provide a degassed fluid and to draw the degassed fluid through the at least one valve and into the at least one syringe pump, and wherein in the dispense configuration, the system controller instructs the at least one syringe pump to push the degassed fluid from the at least one syringe pump through the at least one valve at a flow rate commensurate with a predetermined dilution factor to dilute a sample according to the dilution factor.

In an aspect, a method includes, but is not limited to, drawing a fluid from a fluid source into a syringe pump of an automated system for degassing fluids, the automated system including: a valve system including at least one valve configured to transition between a load configuration and a dispense configuration, a pump system including the syringe pump fluidically coupled with the at least one valve, a degasser fluidically coupled with the at least one valve and configured to fluidically couple with a fluid source, and a system controller communicatively coupled with each of the valve system and the pump system; instructing, via the system controller, the at least one valve to transition to the load configuration to fluidically couple the syringe pump with the degasser; instructing, via the system controller, the syringe pump to draw fluid from the fluid source through the degasser to remove dissolved gases within the fluid to provide a degassed fluid and to draw the degassed fluid through the at least one valve and into the syringe pump; instructing, via the system controller, the at least one valve to transition to the dispense configuration; and instructing, via the system controller, the syringe pump to push the degassed fluid from the syringe pump through the at least one valve at a flow rate commensurate with a predetermined dilution factor to dilute a sample according to the dilution factor.

In an aspect, a system includes, but is not limited to, a syringe pump; a degasser configured to be fluidically coupled between the pump and a fluid source, the degasser configured to remove dissolved gases from a liquid portion of fluid from the fluid source upon drawing the fluid from the fluid source by the syringe pump; and a system controller communicatively coupled with the syringe pump, the system controller configured to instruct the syringe pump to draw the fluid from the fluid source through the degasser to provide degassed fluid into the syringe pump.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. In the figures, the use of the same reference numbers in different instances in the description and the figures may indicate similar or identical items.

FIG. 1 is a schematic diagram of an automated dilution system with degassing of syringe-driven fluids to prepare samples for analysis, in accordance with an embodiment of this disclosure.

FIG. 2 is a schematic diagram of a portion of the system of FIG. 1, in accordance with an embodiment of this disclosure.

FIG. 3A is a schematic diagram of a syringe pump of the system of FIG. 1, shown without degassing of syringe-driven fluids with bubbles present in the syringe pump.

FIG. 3B is a schematic diagram of the syringe pump of FIG. 3A, shown with no bubbles present in the syringe pump as a result of degassing of the fluid prior to introduction to the syringe pump, in accordance with an embodiment of this disclosure.

FIG. 4 is a cross-sectional diagram of a membrane-based degasser shown permitting the passage of gas across the membrane while preventing the passage of liquid to degas liquids, in accordance with an embodiment of this disclosure.

FIG. 5A is a schematic diagram of an automated dilution system with degassing of syringe-driven fluids, shown in a load configuration to degas fluids during loading of syringe pumps, in accordance with an embodiment of this disclosure.

FIG. 5B is a schematic diagram of the automated dilution system of FIG. 5A, shown in a dispense configuration to push degassed fluids from the syringe pumps for dilution of a sample fluid, in accordance with an embodiment of this disclosure.

FIG. 6A is a chart of percent recovery versus dilution factor for a sample containing cobalt without degassing a diluent used to dilute the sample according to a plurality of dilution factors or a carrier fluid used to push the samples to an analysis system.

FIG. 6B is a table showing average percent recovery with standard deviations for a sample containing a plurality of analytes without degassing a diluent used to dilute the sample according to a plurality of dilution factors or a carrier fluid used to push the samples to an analysis system.

FIG. 7A is a chart of percent recovery versus dilution factor for a sample containing cobalt, where a diluent used to dilute the sample according to a plurality of dilution factors and a carrier fluid used to push the samples to an analysis system were degassed with the system of FIG. 1 prior to pushing the sample to the analysis system, in accordance with an embodiment of this disclosure.

FIG. 7B is a table showing average percent recovery with standard deviations for a sample containing a plurality of analytes, where a diluent used to dilute the sample according to a plurality of dilution factors and a carrier fluid used to push the samples to an analysis system were degassed with the system of FIG. 1 prior to pushing the sample to the analysis system, in accordance with an embodiment of this disclosure.

### DETAILED DESCRIPTION

### Overview

Determination of trace elemental concentrations or amounts in a sample can provide an indication of purity of the sample, or an acceptability of the sample for use as a reagent, reactive component, or the like. For instance, in certain production or manufacturing processes (e.g., mining, metallurgy, semiconductor fabrication, pharmaceutical processing, etc.), the tolerances for impurities can be very strict, for example, on the order of fractions of parts per billion. In order to accurately measure trace elemental compositions for highly concentrated samples (e.g., metal ores, metallurgical compositions, etc.), the samples to be measured often require dilution for analysis by ICP spectrometry instrumentation (an Inductively Coupled Plasma Mass Spectrometer (ICP/ICP-MS), an Inductively Coupled Plasma Atomic Emission Spectrometer (ICP-AES), or the like)) or other analytical instrumentation. For instance, if a sample is too concentrated, the sample could saturate the cones of the ICP spectrometry instrumentation, carry over undesirable background between samples, or ruin the instrumentation. However, obtaining accurate dilution factors can be difficult to achieve, particularly where manual techniques often involve relatively large volumes of liquids (e.g., 50 mL or more), delicate pipets or volumetric flasks, instrumentation requiring frequent certification, substantial time requirements, or the like.

Moreover, both automated and manual dilution preparation techniques can introduce errors in analysis of samples, in preparation of calibration curves, or the like, due to the presence of dissolved gases within fluids. Dissolved gases present in the fluids used to dilute samples or to move samples into contact with diluent can form into bubbles or voids (e.g., forming on surfaces of fluid lines, sample vessels, pumps, etc.) due to surface contact with system components or pressure changes. Such bubbles or voids can limit accuracy of sample dilutions by negatively influencing pump action by compressing gas rather than pushing liquids or by taking up space in combinations of fluids.

For instance, if a fluid line includes one or more bubbles, in order for a pump to push liquid within the line, the gas first compresses due to the pressure exerted by the pump before the liquid within the line moves. For pump-controlled systems, that initial movement of the pump to compress the gas before any liquid moves results in dilution error. For example, syringe pumps exert pressure on fluids having dissolved gases in two directions, with a first direction pulling fluid into the syringe to load the pump and a second direction pushing fluid from the syringe to dispense the fluid. The dissolved gases can form bubbles in the syringe pump (e.g., at the fluid/plunger interface, at the fluid/barrel interface) or in a fluid line fluidically coupled with the syringe pump during either direction of fluid movement. As dilution factors for samples increase, the presence of bubbles in the system have increasingly large impacts on dilution accuracy, where smaller sample amounts relative to the diluent are impacted to a larger extent by movement of a syringe pump during the gas compression phase without substantial motion of the fluid to be introduced to relatively large amounts of diluent. For analyses that require high accuracy in the determination of trace elemental concentrations, dissolved gases can limit the ability to accurately and reproducibly achieve high dilution factors.

Moreover, some liquids can include differing amounts of dissolved gases over time, which can be caused by fluctuations in the systems used to produce the fluids, environmental differences over time (e.g., ambient temperatures, pressures, humidity, etc.), geographical differences for diluent preparation and sample preparation or for differing laboratories executing the same sample preparation procedure (e.g., with different altitudes, environmental differences, etc.), the duration of the fluids within a given container, or the like. Such variance in the dissolved gases can make it difficult to predict the impact of the dissolved gases on sample dilutions, such that the impact on dilution accuracy can vary from sample to sample. For instance, even if a correction factor to account for the presence of a particular amount of dissolved gases for a particular analysis can be determined for a particular fluid, that same correction factor may not be reliable for subsequent analyses of the same or similar fluid, since the amount of dissolved gases can change over time, causing the original correction factor to be erroneous for subsequent analyses.

Accordingly, the present disclosure is directed, at least in part, to systems and methods for degassing fluids used in syringe-driven dilution of samples for analysis. In aspects, a system includes a degasser fluidically coupled between a fluid source and a syringe pump such that the degasser removes dissolved gases in fluid drawn from the fluid source by the syringe pump. For instance, the fluid source can include a diluent used in an automated dilution system to dilute a sample drawn by an autosampler for inline sample dilution or pushed through a sample probe of the autosampler into a sample container for offline sample dilution. Alternatively or additionally, the fluid source can include a carrier fluid used in the automated dilution system to push sample into a fluid line or valve for inline dilution by a diluent. As the fluid from the fluid source is degassed before being drawn into the syringe pump, the syringe pump does not include substantial amounts of bubbles in the pump or coupled fluids lines.

As the syringe pump transitions from a loading motion or a stationary position to a pushing motion, the syringe pump can immediately begin pushing the liquid (e.g., diluent or carrier fluid) without wasting motion to compress any intervening bubbles. As such, very accurate dilution factors can be prepared by the syringe-driven fluid, since motion by the plunger of the syringe pump can be attributed to movement of the fluid and not to mere bubble compression. In aspects, the systems described herein can facilitate highly precise and accurate dilution factors of greater than 100x. For example, the systems described herein have been shown to facilitate highly precise and accurate sample dilution for samples having dilution factors of over 400x, including but not limited to, dilutions factors of 1000x and 1500x. Moreover, degassing of the fluid before introduction to the syringe pump allows fluid to remain in the syringe pump or associated fluid lines for long durations of time without bubble formation, for example during system down time for maintenance, between samples, or the like.

### Example Implementations

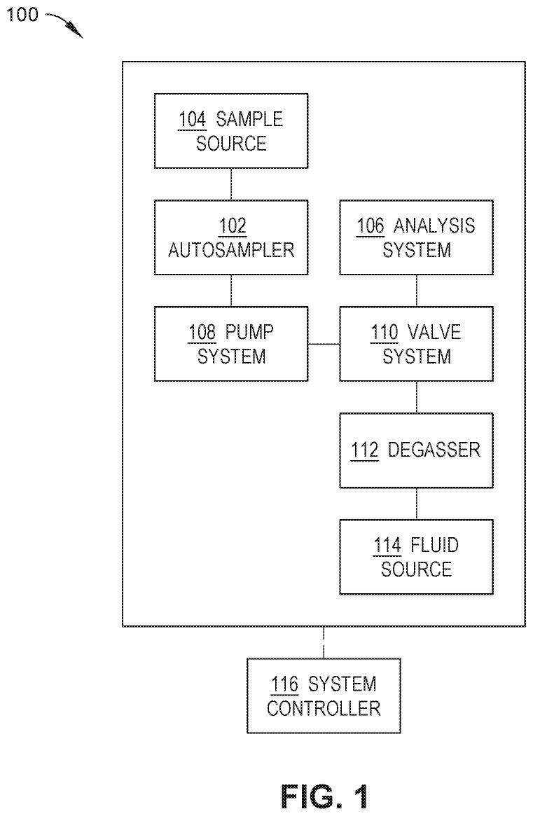

Referring to FIG. 1, a system 100 is shown for degassing fluids used in syringe-driven dilution of samples for analysis, in accordance with an example embodiment of the present disclosure. The system 100 is shown generally including an autosampler 102 operable to take a sample from a sample source 104 (e.g., via a sample probe) for analysis by an analysis system 106. The analysis system 106 can include any system suitable for determination of one or analytes of interest in the sample, including, but not limited to, an inductively-coupled plasma analysis system (e.g., ICP-MS, ICP-AES, ICP-OES, etc.), an organic mass spectrometer, a gas chromatograph (GC), a liquid chromatograph (LC), a liquid chromatograph mass spectrometer (LC-MS), an ion chromatograph (IC), or another analytical instrument or technique to identify the presence, amount, or concentration of one or more analytes of interest within the fluid sample.

The autosampler 102 is fluidically coupled with a pump system 108 and a valve system 110 to transport the sample from the sample source 104 to the analysis system 106, with one or more sample preparation techniques, including, but not limited to, sample dilution, internal standard addition, chemical reactant addition, or the like. The system 100 is shown including a degasser 112 fluidically coupled with the valve system 110 and a fluid source 114 to remove dissolved gases from fluid received from the fluid source 114. For instance, the fluid source 114 can include one or more of a carrier fluid, a diluent, a reactant an internal standard, or another fluid. For example, the fluid source 114 can include a container of fluid including, but not limited to, an acid (e.g., nitric acid, hydrochloric acid, etc.), an organic solvent, water (ultrapure water (UPW), distilled water, deionized water, etc.), or any other fluid suitable for chemical analyses that can be prone to including dissolved gases. The degasser 112 removes dissolved gases from the fluid before introduction of the fluid to sample from the sample source 104, such as to push the sample to the analysis system 106, to provide a precise amount of diluent to the sample, to provide a precise amount of a chemical reactant to the sample, to provide a precise amount of an internal standard to the sample, or combinations thereof.

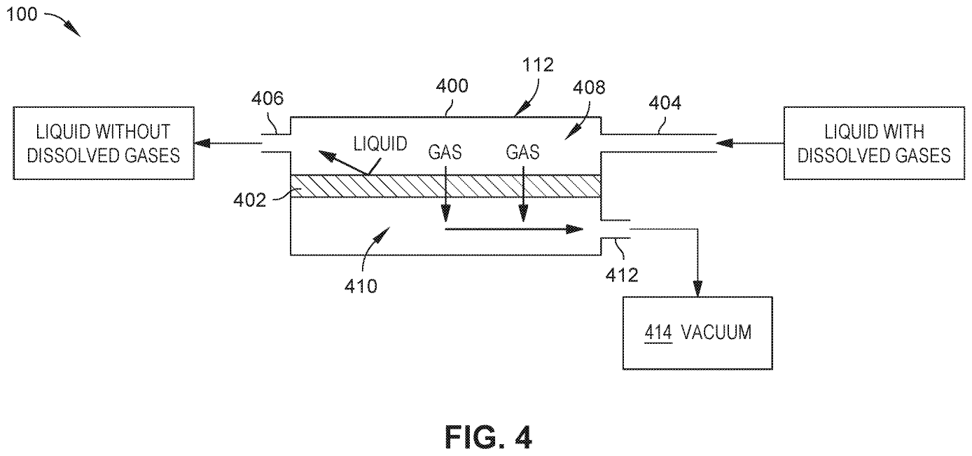

In implementations, the degasser 112 can include a membrane-based degasser incorporating a gas-permeable and liquid-impermeable membrane across which dissolved gases can pass, without passage by the liquid sample component, as described further herein with respect to FIG. 4. The membrane-based degasser can include a planar membrane, a tubular membrane, or the like, or combinations thereof, where the sample is passed in contact with the membrane for gas removal (e.g., through action by the pump system 108). For instance, the pump system 108 can include a vacuum source (e.g., a vacuum pump) fluidically coupled with the degasser 112 to remove gas that has permeated the membrane. In implementations, the membrane can be formed, at least in part, by a polytetrafluoroethylene (PTFE) material, a polyvinylidene fluoride (PVDF) material, or combinations thereof to provide gas permeability while being substantially impermeable to liquid.

The system 100 is also shown including a system controller 116 communicatively coupled with one or more of the components of the system 100, for example, to automatically control and coordinate operations of one or more of the autosampler 102, the pump system 108, the valve system 110, the degasser 112, and the analysis system 106, to facilitate the operations described herein. For example, the system controller 116 can send and receive electric signals between the components of the system 100 to manipulate the configuration of the valve system 110 coordinated with operation of the pump system 108 and the autosampler 102 to degas fluid from the fluid source 114 prior to loading the fluid into one or more syringe pumps of the pump system 108 for dilution of sample for analysis by the analysis system 106.

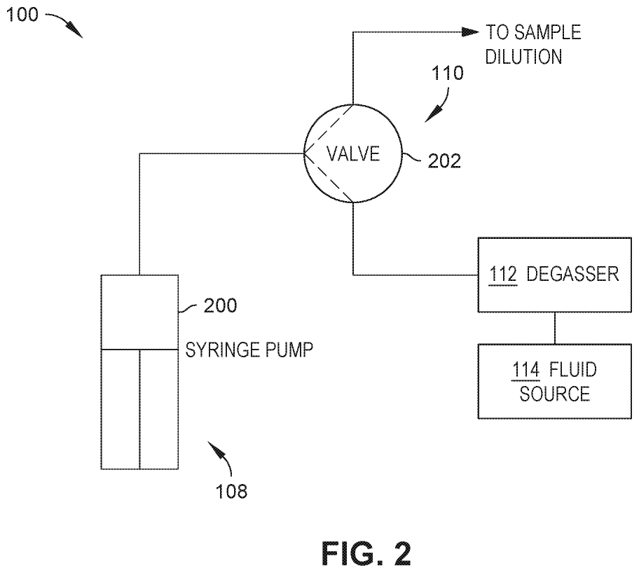

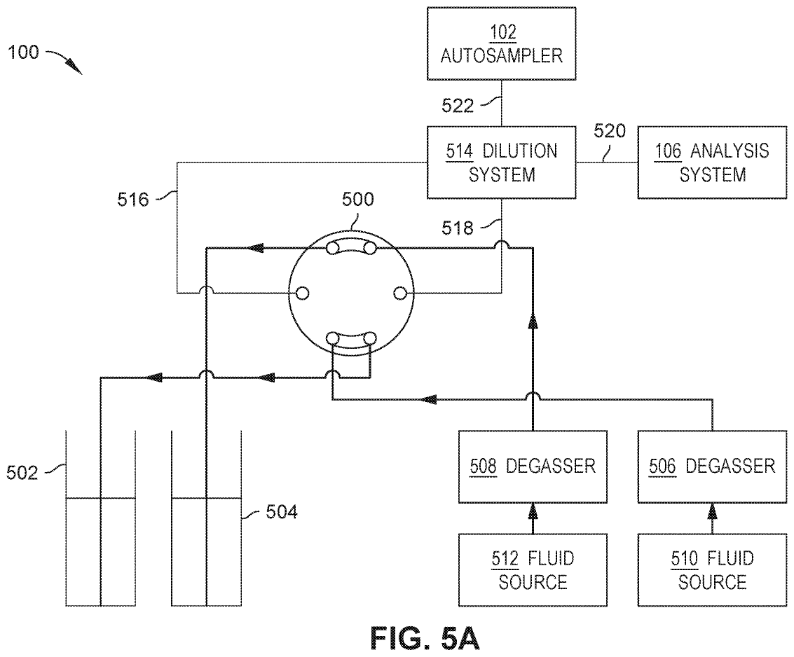

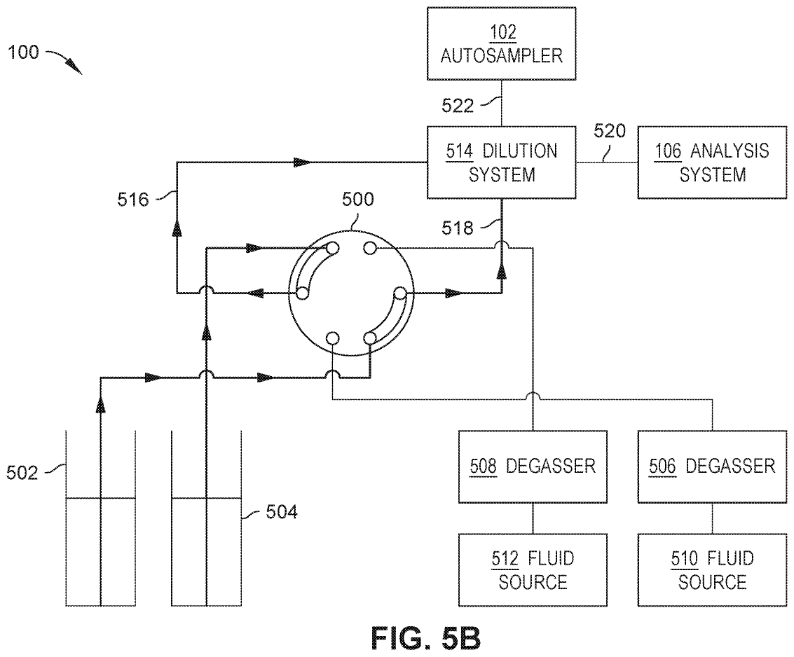

Referring to FIG. 2, the system 100 is shown with the pump system 108 including a syringe pump 200 fluidically coupled with the fluid source 114 via a valve 202 of the valve system 110 with the degasser 112 fluidically coupled between the fluid source 114 and the syringe pump 200. In such a configuration, the syringe pump 200 operates to draw (e.g., with a downstroke of the plunger) fluid from the fluid source 114 through the degasser 112 and through the valve 202 to introduce the fluid into the syringe pump. As the fluid moves through the degasser 112, the degasser 112 removes dissolved gases in the fluid, permitting degassed fluid to flow into the valve 200 for entry into the syringe pump 200. For instance, the fluid source can include a carrier fluid or working fluid used in the system 100 to push sample through the valve system 110 for in-line dilution by a diluent. For example, a diluent can be introduced to a flow of the sample in a valve of the valve system 110, in a fluid line junction (e.g., T-junction, fluid flow manifold, etc.), or combinations thereof according to a dilution factor for the sample for analysis by the analysis system 106. In implementations, the diluent can also be sourced from the fluid source 114 for introduction to the degasser 112, as described further herein with respect to FIGS. 5A and 5B.

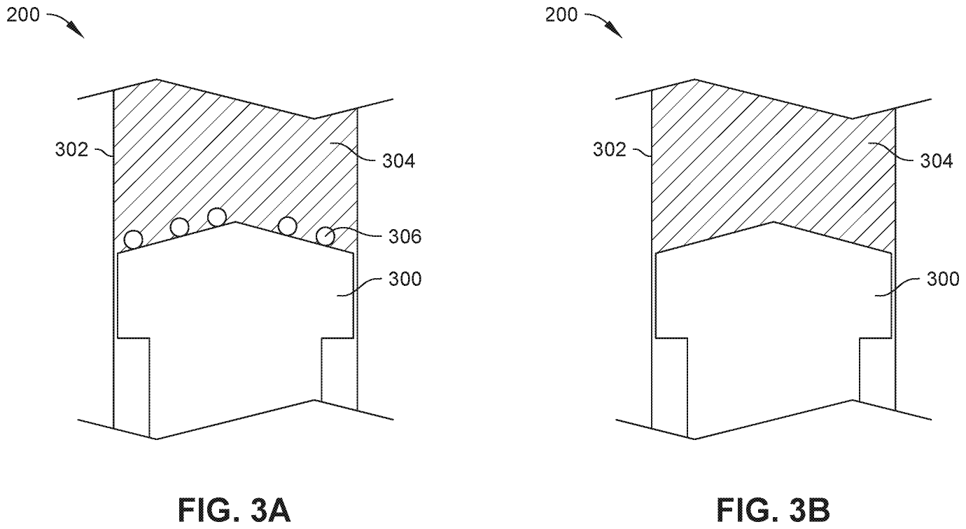

As the fluid from the fluid source 114 is degassed before being drawn into the syringe pump 200, the syringe pump 200 does not include substantial amounts of bubbles in the pump or coupled fluids lines. As the syringe pump 200 transitions to a pushing motion, the syringe pump 200 can immediately begin pushing the fluid without wasting motion of the plunger to compress any intervening bubbles. For instance, motion by the plunger of the syringe pump 200 to push the liquid carrier fluid is directly attributed to movement of the carrier fluid, since no portion of the motion by the plunger is utilized to compress dissolved gases, allowing a precise translation between plunger motion and a volume of fluid dispensed by the syringe pump 200 for introduction of sample to diluent. The syringe pump 200 is shown in FIG. 3A in an example configuration having drawn a fluid from the fluid source 114 without operation by the degasser 112 (e.g., without prior degassing of the fluid). For instance, the syringe pump 200 includes a plunger 300 within a barrel 302 to draw fluid from the fluid source 114 into the barrel 302 upon a downstroke of the plunger 300 (e.g., controlled by a motor, not shown) relative to the barrel 302 and to push fluid out of the barrel 302 upon an upstroke of the plunger 300 (e.g., controlled by a motor, not shown) relative to the barrel 302. The barrel 302 is shown containing fluid 304 that was not degassed and therefore contains bubbles 306 that displace the fluid 304 adjacent the plunger 300 (e.g., at an interface between the fluid 304 and the plunger 300) of the syringe pump 200. Upon activation of the plunger 300, the syringe pump 200 compresses the bubbles 306 due to pressure differential, causing a portion of the motion of the plunger 300 to not transport the fluid 304. Since dilution factors can be attributed to linear motion of the plunger 300 to introduce relative amounts of sample and diluent, the presence of the bubbles 306 introduces error when diluting sample from the autosampler 102.

The syringe pump 200 is shown in FIG. 3B in an example configuration having drawn a fluid from the fluid source 114 coincident with operation by the degasser 112 (e.g., with prior degassing of the fluid). For instance, the barrel 302 is shown containing fluid 304 that was degassed by the degasser 112 and therefore does not contain bubbles 306, with only fluid 304 adjacent the plunger 300. Upon activation of the plunger 300, there are no bubbles 306 for the syringe pump 200 to compress, therefore no motion of the plunger 300 is wasted, where the motion can directly cause transport of the fluid 304. Since dilution factors can be attributed to linear motion of the plunger 300 to introduce relative amounts of sample and diluent, the absence of bubbles 306 provides accurate and precise dilution of sample from the autosampler 102.

Referring to FIG. 4, the degasser 112 is shown in accordance with an example implementation including a degassing chamber 400 housing a degassing membrane 402. The degassing chamber 400 includes an inlet 404 fluidically coupled with a source of liquid with dissolved gases entrained therein, such as, for example, the fluid source 114, and a liquid outlet 406 to permit degassed fluid to exit the degassing chamber 400. For example, the liquid outlet 406 can be fluidically coupled with the valve system 108 to permit fluid connection with the pump system 108 (e.g., a syringe pump). The degassing membrane 402 divides the degassing chamber 400 into a fluid chamber 408 and a gas chamber 410. Fluid entering the degassing chamber 400 via the inlet 404 transfers through the fluid chamber 408 and to the liquid outlet 406, supported by the degassing membrane 402. The degassing membrane 402 is formed from a gas-permeable and liquid-impermeable material to permit the passage of dissolved gases present in the fluid in the fluid chamber 408 into the gas chamber 410, while preventing passage by the liquid sample component, maintaining the liquid in the fluid chamber 408. For example, the degassing membrane 402 can be formed, at least in part, by a polytetrafluoroethylene (PTFE) material, a polyvinylidene fluoride (PVDF) material, or combinations thereof to provide gas permeability while being substantially impermeable to liquid. The degassing chamber 400 includes a gas outlet 412 in the gas chamber 410 to permit gases that passed through the degassing membrane 402 to be removed from the degassing chamber 400. For example, the gas outlet 412 can be coupled with a vacuum 414, such as a vacuum pump, to remove gases from the gas chamber 410 and to promote the passage of gas across the degassing membrane 402. The vacuum source 414 can operate according to any suitable operation schedule to remove gases from the gas chamber 410, such as on a continuous basis, on a periodic basis, on a duty cycle, coordinated with operation of the syringe pump 200, or the like. The force of the vacuum 414 can be controlled to accommodate the desired flow rate of the fluid drawn from the fluid source 114.

The system 100 can facilitate the degassing of multiple fluids from multiple fluid sources to provide the fluids for sample dilution (e.g., by a degassed diluent) and sample transfer (e.g., by a degassed working fluid). For example, referring to FIGS. 5A and 5B, the system 100 is shown with a valve 500 of the valve system 110 fluidically coupled with a first syringe pump 502, a second syringe pump 504, a first degasser 506, and a second degasser 508 to degas fluids received from a first fluid source 510, and a second fluid source 512. The valve 500 can include a rotary valve to change configurations to provide differing fluid flow pathways through the system 100. For example, the valve 500 is shown in FIG. 5A in a load configuration to fluidically couple the first syringe pump 502 with the first fluid source 510 (via the first degasser 506) and to fluidically couple the second syringe pump 504 with the second fluid source 512 (via the second degasser 508). In the load configuration, the first syringe pump 502 draws fluid from the first fluid source 510 through the first degasser 506 to remove dissolved gas from the fluid prior to entry into the valve 500 and into the first syringe pump 502. Similarly, the second syringe pump 504 draws fluid from the second fluid source 512 through the second degasser 508 to remove dissolved gas from the fluid prior to entry into the valve 500 and into the second syringe pump 504. Since the syringe pumps 502, 504 contain degassed fluids the fluids remain in a degassed state until the system 100 is ready to dispense the fluids. While the system 100 is shown including two degassers 506, 508 and two fluid sources 510, 512, the system 100 is not limited to such configuration, where it will be appreciated that the system 100 can be configured with a single degasser to handle multiple fluid sources, can be configured with a single fluid source to provide fluid to multiple syringe pumps, or the like, or combinations thereof without departing from the scope of the present disclosure.

The system 100 is also shown coupling the valve 500 with a dilution system 514 via fluid transfer lines 516, 518, however in the load configuration, the dilution system is fluidically isolated from the syringe pumps 502, 504. The dilution system 514 can include additional portions of the valve system 110, fluid holding lines, and the like, to facilitate transfer and combination of fluids within the system 100 to provide a diluted sample according to a variety of dilution factors. For example, in an implementation, the autosampler 102 transfers a sample into a fluid holding line of a predetermined volume to capture a known amount of sample for later dilution and analysis.

Referring to FIG. 5B, following loading of the syringe pumps 502, 504 with degassed fluids, the system 100 transitions to a dispense configuration to facilitate the transfer of fluids from the loaded syringe pumps 502, 504 to the dilution system 514. For instance, in the dispense configuration, the valve 500 fluidically couples the first syringe pump 502 with the dilution system 514 via the fluid transfer line 518 and fluidically couples the second syringe pump 504 with the dilution system 514 via the fluid transfer line 516. In the dispense configuration, the first syringe pump 502 pushes degassed fluid through the valve 500 into the fluid transfer line 518 for introduction to the dilution system 514 and the second syringe pump 504 pushes degassed fluid through the valve 500 into the fluid transfer line 516 for introduction to the dilution system 514. For example, the first syringe 502 can transfer a degassed carrier fluid or degassed working fluid to push a sample from the autosampler 102 held at the dilution system 514 (e.g., within a fluid holding line) to the analysis system 106 via fluid line 520, with or without prior contact with a stream of diluent. For example, second syringe 504 can transfer a degassed diluent to the dilution system 514, which can include a valve configuration to direct the degassed diluent to the sample, such as while the sample is being pushed by the degassed carrier fluid through operation of the first syringe pump 502. In implementations, the dilution system 514 can direct degassed diluent from the second syringe pump 504 to the autosampler 102 via fluid line 522, where the autosampler 102 can position a sample probe above a fluid container (e.g., test tube, sample bottle, etc.) to receive a precise amount of diluent for introduction to a precise amount of sample to achieve a desired dilution factor in an offline dilution.

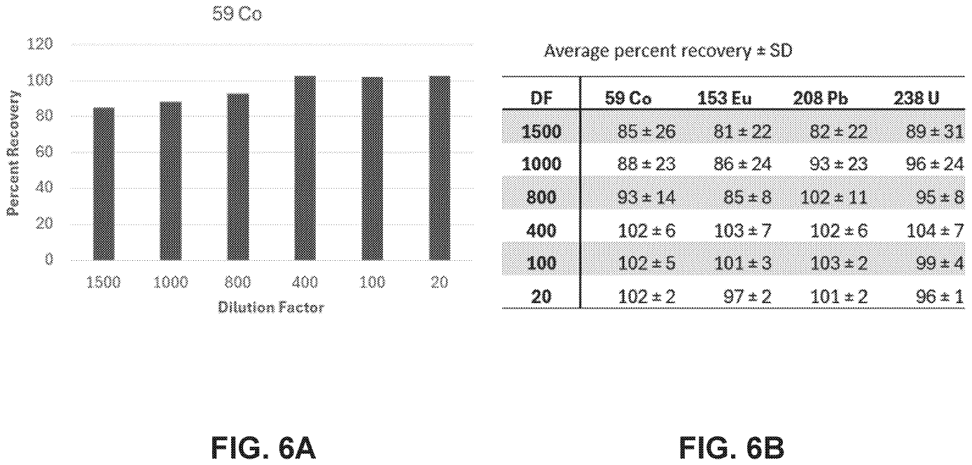

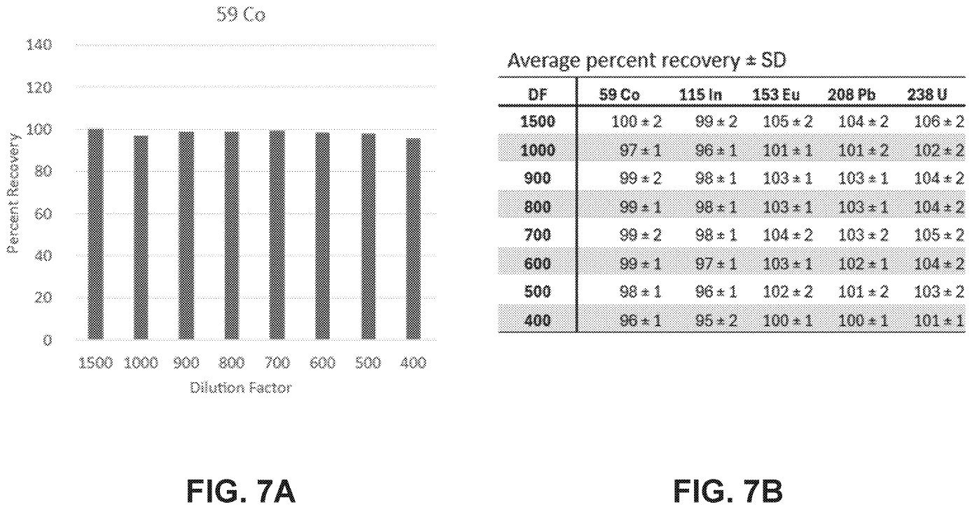

A comparison of sample analysis using non-degassed fluids for sample dilution and of sample analysis using degassed fluids for sample dilution is shown with references to FIGS. 6A through 7B. For instance, FIGS. 6A and 6B show data associated with sample analyses using non-degassed carrier fluids for pushing a fluid sample into contact with non-degassed diluents for sample dilution utilizing a variety of dilution factors including high dilution factors of 1500x, 1000x, 800x, and 400x. For example, to achieve a dilution factor of 20x, a first syringe pump can operate at a rate of 50 μL/sec to push carrier fluid against sample in sample holding line and a second syringe pump can operate at a rate of 950 μL/sec to push diluent into contact with the sample. Referring to FIG. 6B, the standard deviations for percent recovery of all analytes tested (e.g., 59 Co, 153 Eu, 208 Pb, 238 U) provide an indication of unreliability of analytical results, with increasing unreliability at dilution factors at and above 400x. This unreliability is related to the dissolved gases present in the carrier fluid and diluent, where the syringe pumps used to deliver the carrier fluid and diluent had inconsistency in translating linear motion of the plunger to fluid movement, due to inconsistent presence of bubbles and the associated gaseous compression.

Referring to FIGS. 7A and 7B, data is shown associated with sample analyses having carrier fluid and diluent degassed by the system 100, with degassed carrier fluids for pushing a fluid sample into contact with degassed diluents for sample dilution utilizing a variety of dilution factors including high dilution factors of 1500x, 1000x, 800x, and 400x. For example, to achieve a dilution factor of 400x, the system controller 116 can direct the first syringe pump 502 to operate at a rate of 50 μL/sec to push degassed carrier fluid against sample in sample holding line in the dilution system 514 and to operate the second syringe pump to operate at a rate of 19,950 μL/sec to push degassed diluent into contact with the sample. Referring to FIG. 7B, the data shows that for all samples shown, even those utilizing high dilution factors (e.g., 1500x, 1000x, 800x, 400x), the standard deviations for percent recovery of all analytes tested (e.g., 59 Co, 115 In, 153 Eu, 208 Pb, 238 U) provide an indication of highly reliable analytical results. This reliability is related to the absence of dissolved gases in the carrier fluid and diluent due to degassing by the system 100. As such, the syringe pumps used to deliver the carrier fluid and diluent had consistency and reliability in translating linear motion of the plunger to fluid movement due to the absence of bubbles, so negligible motion of the plunger is utilized for gaseous compression. For high dilution factors, the amount of sample introduced to diluent gets smaller as the dilution factor increases, so even small deviations in the pumping rate of carrier fluid used to push the sample can result in large errors of the amount of sample present in a diluted sample. By degassing the carrier fluid and the diluent, the system 100 is shown to provide highly reliable and accurate analytical results for sample dilutions, even with high dilution factors.

Electromechanical devices (e.g., electrical motors, servos, actuators, or the like) may be coupled with or embedded within components of the system 100 (e.g., the valves, the syringe pumps, and combinations thereof) to facilitate automated operation via control logic embedded within or externally driving the system 100, coordinated by the system controller 116. The electromechanical devices can be configured to cause the plurality of valves to direct fluid flows from syringes, valves, flow paths, etc., according to one or more modes of operation, such as those described herein. The system 100 may include or be controlled by a computing system having a processor configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the autosampler 102, the degasser 112, the syringe pump 200, and any of the various pumps or valves described herein. The program instructions, when executing by the processor, can cause the computing system to control the system 100 (e.g., control the pumps and selection valves) according to one or more modes of operation, as described herein.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### Conclusion

It will be appreciated that features described herein with respect to embodiments or implementations can be combined with any other feature or features described with respect to the same or alternative embodiments, unless context otherwise dictates, without departing from the scope of the present disclosure.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

1. An automated system for degassing fluids used in syringe-driven dilution of samples for analysis, comprising:
a valve system including at least one valve configured to transition between a load configuration and a dispense configuration;
a pump system including at least one syringe pump fluidically coupled with the at least one valve;
a degasser fluidically coupled with the at least one valve and configured to fluidically couple with a fluid source; and
a system controller communicatively coupled with each of the valve system and the pump system, the system controller configured to instruct the at least one valve to transition between the load configuration and the dispense configuration and to coordinate operation of the at least one syringe pump, wherein in the load configuration, the at least one valve fluidically couples the at least one syringe pump with the degasser and the system controller instructs the at least one syringe pump to draw fluid from the fluid source through the degasser to remove dissolved gases within the fluid to provide a degassed fluid and to draw the degassed fluid through the at least one valve and into the at least one syringe pump, and wherein in the dispense configuration, the system controller instructs the at least one syringe pump to push the degassed fluid from the at least one syringe pump through the at least one valve at a flow rate commensurate with a predetermined dilution factor to dilute a sample according to the dilution factor.

2. The automated system of claim 1, wherein the degasser includes a gas-permeable and liquid-impermeable membrane.

3. The automated system of claim 2, wherein the degasser includes a degassing chamber having an inlet configured to receive the fluid from the fluid source into the degassing chamber, a liquid outlet configured remove the degassed fluid from the degassing chamber, and a gas outlet configured to remove dissolved gases that permeate the gas-permeable and liquid-impermeable membrane from the degassing chamber.

4. The automated system of claim 3, wherein the gas-permeable and liquid-impermeable membrane divides the degassing chamber into a fluid chamber and a gas chamber, wherein the fluid chamber contains the inlet and the liquid outlet, and wherein the gas chamber includes the gas outlet.

5. The automated system of claim 3, further comprising a vacuum source fluidically coupled with the gas outlet.

6. The automated system of claim 1, wherein the pump system includes a second syringe pump fluidically coupled with the valve system and with a second degasser to draw from a second fluid source through a second degasser to provide a second degassed fluid.

7. The automated system of claim 6, wherein in the dispense configuration, the system controller instructs the second syringe pump to push the second degassed fluid through the at least one valve at a second flow rate commensurate with the predetermined dilution factor to dilute the sample according to the dilution factor.

8. The automated system of claim 7, wherein the fluid from the fluid source is a carrier fluid, and wherein the second fluid from the second fluid source is a diluent.

9. The automated system of claim 1, wherein the dilution factor is at least 400x.

10. A method for degassing fluids used in syringe-driven dilution of samples for analysis, comprising:
drawing a fluid from a fluid source into a syringe pump of an automated system for degassing fluids, the automated system including:
a valve system including at least one valve configured to transition between a load configuration and a dispense configuration,
a pump system including the syringe pump fluidically coupled with the at least one valve,
a degasser fluidically coupled with the at least one valve and configured to fluidically couple with a fluid source, and
a system controller communicatively coupled with each of the valve system and the pump system;
instructing, via the system controller, the at least one valve to transition to the load configuration to fluidically couple the syringe pump with the degasser;
instructing, via the system controller, the syringe pump to draw fluid from the fluid source through the degasser to remove dissolved gases within the fluid to provide a degassed fluid and to draw the degassed fluid through the at least one valve and into the syringe pump;
instructing, via the system controller, the at least one valve to transition to the dispense configuration; and
instructing, via the system controller, the syringe pump to push the degassed fluid from the syringe pump through the at least one valve at a flow rate commensurate with a predetermined dilution factor to dilute a sample according to the dilution factor.

11. The method of claim 10, wherein the degasser includes a gas-permeable and liquid-impermeable membrane.

12. The method of claim 11, wherein the degasser includes a degassing chamber having an inlet configured to receive the fluid from the fluid source into the degassing chamber, a liquid outlet configured remove the degassed fluid from the degassing chamber, and a gas outlet configured to remove dissolved gases that permeate the gas-permeable and liquid-impermeable membrane from the degassing chamber.

13. The method of claim 12, wherein the gas-permeable and liquid-impermeable membrane divides the degassing chamber into a fluid chamber and a gas chamber, wherein the fluid chamber contains the inlet and the liquid outlet, and wherein the gas chamber includes the gas outlet.

14. The method of claim 12, further comprising activating, via the system controller, a vacuum source fluidically coupled with the gas outlet to remove dissolved gases that permeate the gas-permeable and liquid-impermeable membrane from the degassing chamber.

15. The method of claim 10, wherein the pump system includes a second syringe pump fluidically coupled with the valve system and with a second degasser to draw from a second fluid source through a second degasser to provide a second degassed fluid.

16. The method of claim 15, wherein in the dispense configuration, the system controller instructs the second syringe pump to push the second degassed fluid through the at least one valve at a second flow rate commensurate with the predetermined dilution factor to dilute the sample according to the dilution factor.

17. The method of claim 16, wherein the fluid from the fluid source is a carrier fluid, and wherein the second fluid from the second fluid source is a diluent.

18. The method of claim 10, wherein the dilution factor is at least 400x.

19. An automated system for degassing fluids used in syringe-driven dilution of samples for analysis, comprising:
a syringe pump;
a degasser configured to be fluidically coupled between the pump and a fluid source, the degasser configured to remove dissolved gases from a liquid portion of fluid from the fluid source upon drawing the fluid from the fluid source by the syringe pump; and
a system controller communicatively coupled with the syringe pump, the system controller configured to instruct the syringe pump to draw the fluid from the fluid source through the degasser to provide degassed fluid into the syringe pump.

20. The automated system of claim 19, wherein the degasser includes a gas-permeable and liquid-impermeable membrane.
